(19) United States
(12) Patent Application Publication
(10) Pub. No.: US 2007/0235569 A1
(43) Pub. Date: Oct. 11, 2007

(54) Coil For Actuating and Heating Fuel Injector

(75) Inventors: Michael J. Hornby, Williamsburg, VA (US); John F. Nally JR., Williamsburg, VA (US); Hamid Sayar, Newport News, VA (US); Perry Robert Czimmek, Williamsburg, VA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS VDO AUTOMOTIVE CORPORATION, Auburn Hills, MI (US)

(21) Appl. No.: 11/692,344

(22) Filed: Mar. 28, 2007

Related U.S. Application Data
(60) Provisional application No. 60/786,576, filed on Mar. 28, 2006.

(51) Int. Cl. F02M 51/00; B05B 1/30

(52) U.S. Cl. 239/585.1

(57) ABSTRACT

A fuel injector includes a common coil that both actuates a pole-piece and provides inductive heating to a fuel flow path. In one example, a first magnetic field is generated to move the pole-piece in response to a DC signal. A structure within the fuel injector near the fuel flow path is excited and heated in response to a AC signal to the coil that generates a second magnetic field.

### CROSS REFERENCE TO RELATED APPLICATION

The application claims priority to U.S. Provisional Application No. 60/786,576 which was filed on Mar. 28, 2006.

### BACKGROUND

This application generally relates to a fuel injector for a combustion engine. More particularly, this invention relates to a fuel injector that heats fuel to aid the combustion process.

Combustion engine suppliers continually strive to improve emissions and combustion performance. Once method of improving both emissions and combustion performance includes heating or vaporizing fuel prior to entering the combustion chamber. Starting a combustion engine often results in undesirably high emissions since the engine has not yet attained an optimal operating temperature. Heating the fuel replicates operation of a hot engine, and therefore improves performance. Further, alternative fuels such as ethanol can perform poorly in cold conditions, and therefore also may benefit from pre-heating of fuel.

Various methods of heating fuel at a fuel injector have been employed. Such methods include the use of a ceramic heater, or resistively heated capillary tube within which the fuel passes. In another example, positive temperature coefficient (PTC) heating elements have been used. One disadvantage of these devices is that that they do not heat the fuel quickly or hot enough to have the desired effect at start-up. Another disadvantage of prior art fuel injector heaters is that the wires to the heater are often in the fuel flow path, which is undesirable if the insulation about the wires fails. These wires also create an additional potential fuel leakage path.

What is needed is a fuel injector having a heater that does not create additional fuel leak paths while still providing rapid heating and vaporization of fuel.

### SUMMARY

A fuel injector includes a common member that provides both an actuator and a heater. The member generates a first magnetic field in response to a DC signal, for example, to move a pole-piece between open and closed positions for providing fuel to a combustion chamber. The same member generates a second magnetic field in response to an AC signal, for example, to inductively heat a structure within the fuel injector. In one example, a fuel flow path is arranged between the pole-piece and the structure.

A driver is in communication with the member and provides the AC signal superimposed over the DC signal, for example, to heat the fuel and move the pole-piece, respectively.

### BRIEF DESCRIPTION OF THE DRAWINGS

FIG. 1 is a cross-section of an example fuel injector assembly.

FIG. 2 a schematic view of the example fuel injector assembly.

FIG. 3A schematically depicts a DC signal used to modulate an actuator with an AC signal superimposed on the DC signal to provide inductive heating.

FIG. 3B schematically depicts a DC signal used to open and close the fuel injector without providing inductive heat.

### DETAILED DESCRIPTION OF THE PREFERRED EMBODIMENT

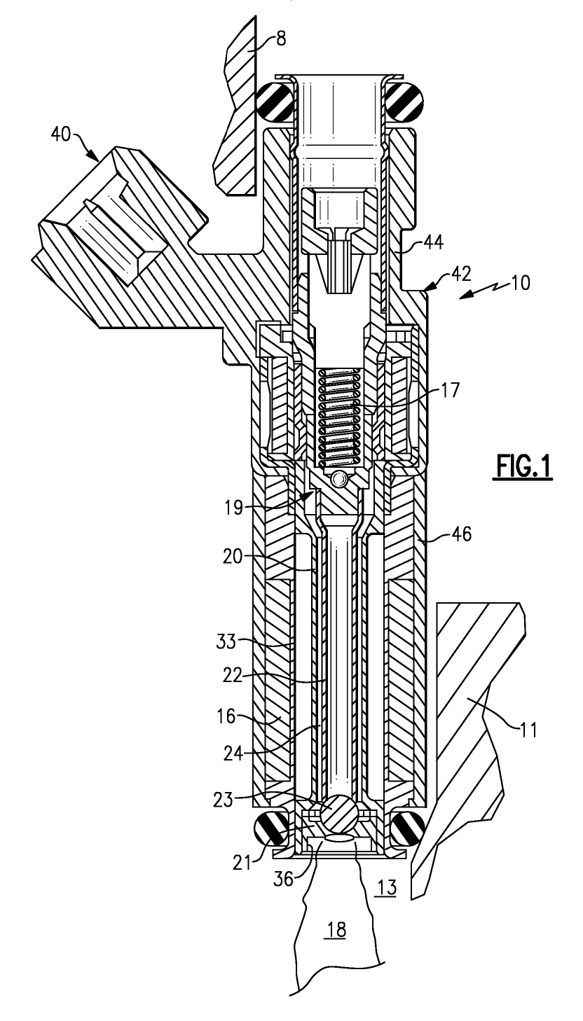

An example fuel injector 10 is shown in FIG. 1. Typically, the fuel injector 10 receives fuel from a fuel rail 8. The fuel injector 10 provides fuel 18 to a combustion chamber 13 of a cylinder head 11, for example, through an outlet 36. Typically, it is desirable to provide well atomized fuel from the outlet 36 to the combustion chamber 13 for more complete combustion and reduced emissions, particularly during cold start conditions.

The fuel injector 10 includes a pole-piece 19 that is actuated between open and closed positions. The pole-piece 19 includes an armature tube 22 that supports a ball 23 received by a seat 22 when the pole-piece 19 is in a closed position, which is shown in the figures. A return spring 17 biases the ball 23 to the closed position. The ball 23 is spaced from the seat 21 in the open position to provide fuel to the combustion chamber 13.

A coil 16 is arranged near the outlet 36 in the example shown. The coil 16 heats the fuel within an annular flow path 24 arranged between a valve body 20 and the armature tube 22. In one example, the coil 16 inductively heats the valve body 20 and/or the armature tube 22. In the example, a barrier 33 seals the coil 16 relative to the internal passages of the fuel injector 10. Electrical wires (shown in FIG. 2) are connected between the coil 16 and pins provided by a connector 40 of a shell 42 (FIG. 1). In one example, the shell 42 includes first and second portions 44, 46 that are over-molded plastic arranged about the internal fuel injector components. In one example, the coil 16 is arranged between the barrier 33 and the second portion 46. The wires from the coil 16 to the connector 40 do not extend to the interior passages of the fuel injector carrying fuel, but rather are contained within the shell 42 outside of the annular flow path 24, for example.

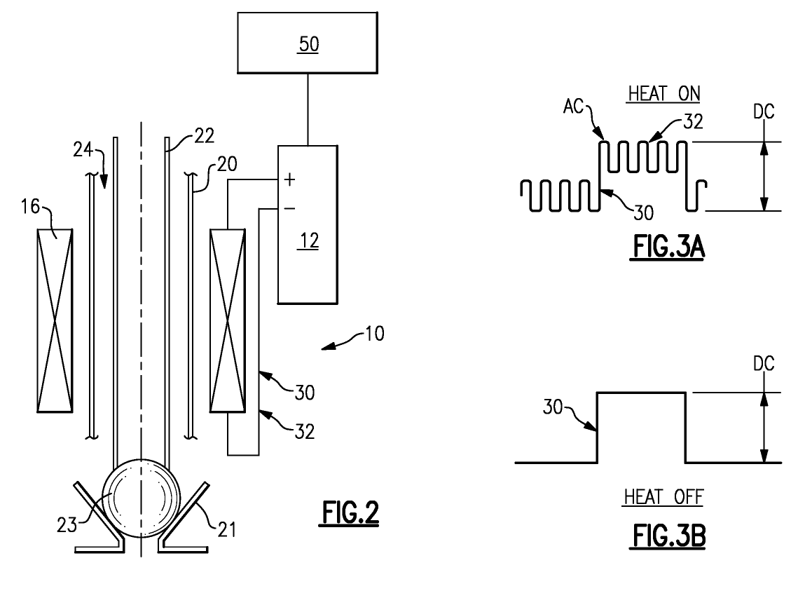

In one example, a driver 12 provides a DC signal 30 to the coil 16, which is shown schematically in FIG. 2. In one example shown in FIG. 3B, the DC signal 30 is a square tooth wave modulated between 0 and 14 volts. The DC signal 30 generates a first magnetic field that induces an axial movement of the pole-piece 19, as is known.

The driver 12 also provides an AC signal 32, for example 70 volts at 40 kHz, to the coil 16. The AC signal 32 produces a time varying and reversing second magnetic field that heats up the components within the field. Heat is generated within the valve body 20 and/or armature tube 22 by hysteretic and eddy-current losses by the magnetic field. The amount of heat generated is responsive to the specific resistivity of the material being acted upon and the generation of an alternating flux. The time varying magnetic field produces a flux flow in the surface of the material that alternates direction to generate heat. The higher resistivity of the material, the better the generation of heat responsive to the magnetic field. The heated valve body 20 and/or armature tube 22 rapidly transfers heat to the fuel within the annular flow path 24 to provide a well vaporized fuel exiting the outlet 36 when the pole-piece 19 is opened.

In the example fuel injector, a single coil is used to provide the actuator and heater. In this manner, the number of components may be reduced, and the number of wires required for each injector can be reduced to two in the example. In one example, the driver 12 sends a DC signal with an AC signal superimposed on the DC signal, as shown in FIG. 3A. The DC signal 30 actuates the pole-piece 19. In the example, the DC signal 30 does not generate any heating effect. The AC signal 32, however, induces a magnetic field that conductively heats the valve body 20 and/or armature tube 22. In the example, the AC signal 32 does not move the pole-piece 19.

The driver 12 and the controller 50 are exterior to the fuel injector 10 in the example shown. The driver 12 can be separate structures and/or software, as shown, or integrated with one another and/or the controller 50.

Although a preferred embodiment has been disclosed, a worker of ordinary skill in this art would recognize that certain modifications would come within the scope of the claims. For that reason, the following claims should be studied to determine their true scope and content.

What is claimed is:

1. A fuel injector assembly comprising:
a pole-piece moveable between open and closed positions to selectively provide fuel;
a member arranged near the pole-piece and a fuel flow path arranged near the member, the member configured to move the pole-piece between the open and closed positions responsive to the first signal, and the same member configured to generate a heat near the fuel flow path responsive to the second signal.

2. The fuel injector assembly according to claim 1, wherein the member is a coil configured to generate first and second magnetic fields responsive to the first and second signals, respectively.

3. The fuel injector assembly according to claim 1, wherein the first signal is a DC signal.

4. The fuel injector assembly according to claim 1, wherein the second signal is an AC signal.

5. The fuel injector assembly according to claim 4, wherein the AC signal is superimposed over a DC signal, the DC signal corresponding to the first signal.

6. The fuel injector assembly according to claim 1, comprising a structure near the fuel flow path, wherein the member is an inductive heater configured to generate a magnetic field exciting and generating heat in the structure.

7. The fuel injector assembly according to claim 6, wherein the pole-piece is different than the structure.

8. The fuel injector assembly according to claim 7, wherein the structure and the pole-piece provide an annular fuel flow path.

9. The fuel injector assembly according to claim 1, comprising a driver in communication with the member and configured to generate the first and second signals.

10. A method of operating a fuel injector assembly comprising the steps of:
a) providing a first signal to a member to move a pole-piece between open and closed positions; and
b) providing a second signal to the same member to heat a fuel flow path.

11. The method according to claim 10, wherein the member is a coil, the coil generating a first magnetic field in response to the first signal, the first magnetic field moving the pole-piece, the coil generating a second magnetic field different than the first magnetic field in response to the second signal, the second magnetic field heating the fuel flow path.
